(19) United States
(12) Patent Application Publication
(10) Pub. No.: US 2003/0161602 A1
(43) Pub. Date: Aug. 28, 2003

(54) Emulsions and microemulsions for use in processing and repairing optical fibers

(76) Inventor: John Grunwald, Tel Aviv (IL)

Correspondence Address: John L. Cordani, Carmody & Torrance LLP, 50 Leavenworth Street, P.O. Box 1110, Waterbury, CT, 06721-1110, US

(21) Appl. No.: 10/348,498

(22) Filed: Jan. 21, 2003

(30) Foreign Application Priority Data
Feb. 25, 2002 (IL) 148350

(51) Int. Cl. G02B 6/02

(52) U.S. Cl. 385/128; 385/147

(57) ABSTRACT

The present invention is related to the use of emulsions and preferably microemulsions in the manufacture and repair of optical fibers.

### FIELD OF THE INVENTION

The present invention is in the field of optical fibers processing.

### BACKGROUND OF THE INVENTION

Optical fibers are gaining rapid and growing acceptance in the field of communication, principally because of their ability to carry signals at speeds that are incomparably faster than afforded by copper.

Optical fibers are generally composed of silica-based glass core covered with a primary polymeric coating, also called inner coating, and a secondary polymeric coating also called outer coating.

Both primary and secondary coatings have to fulfill stringent adhesion requirements, which is especially true for the primary coating. Indeed, the primary coating has to protect the glass core against hostile environment such as moisture, thermal constraints, hydrogen, and others, all of which adversely affect its functionality and useful life. Typically, in order to improve adhesion, coatings will contain adhesion promoters, generally organofunctional silanes, to enhance silica-to-polymer bond. In addition to their incorporation in the coating, they can also be applied from organic solvents, or even carrier gas as disclosed in US Application 20000616103 (corresponding to WO 02/06176 ), potentially causing environmental concerns.

The color-coded optical fibers are typically arranged side-by-side to form an optical ribbon, usually contained within a polymeric resin matrix. The optical ribbons are held together by a fiber optic cable. U.S. Pat. No. 6,317,543 discloses the use of oil or other “fluidbase” lubricants in the manufacture of optical cables. Above patent is mentioned to show the intricacies of manufacturing optical cables, requiring the use of an inordinate diversity of materials, techniques, and disciplines.

While adhesion of the fiber optic coating to a given substrate, whether glass core or a coating underneath must be strong, it has to be carefully balanced not to be “too strong”, in order to also allow strippability for needed repairs, for solderability-enhancing metallization as exemplified in U.S. Pat. No. 5,380,559, etc. Satisfying the needs for adhesion and strippability are seemingly opposing needs. Still they need to be addressed.

The prior art discloses a great variety of stripping methods, mechanical, chemical, thermal, via lasers, or combinations thereof. Chemical stripping usually utilizes organic solvents, with their potential environmental and safety problems. Some of the patents even suggest wiping the surface after chemical stripping, that can be tedious. Thus, the abundance of prior art patents dealing with stripping optical fibers, is possibly a reflection of the difficulties and ongoing search for a better way to remove coatings as/wherever needed.

It can be seen from the foregoing, that construction of optical fibers, being a relatively new technology, presents uniquely complex problems involving a multitude of diverse materials such as glass, different kinds of polymers, inorganic materials, metals, interfaces, etc. The suggested use of emulsions/microemulsions as taught in this patent, offers an additional tool with significant potential benefits to advance the art of optical fibers.

Following are some recent patents that deal with bonding, stripping, repairing optical fibers.

Bonding:

U.S. Pat. Nos. 6,326,416, 6,134,364, EP 0996008, 1049948

Stripping:

U.S. Pat. Nos. 6,056,847, 6,222,969, 6,274,296, WO 0177714

Repairing:

WO 0173793, U.S. Pat. Nos. 5,860,948, 5,430,270

Finally, U.S. Pat. Nos. 3,579,365, 3,533,727, 3,607,473, 3,716,392 and 3,533,727 are teaching methods and compositions using microemulsions in the treatment of molded plastic prior to electroplating. Some of the compositions can serve as helpful guides in practicing this invention, especially as they relate to techniques of preparing the emulsions.

### SUMMARY OF THE INVENTION

It is the principal broad aspect of this invention to advance the art of manufacturing, processing, repairing, recycling, of optical fibers through the use of emulsion, preferably microemulsions. For the purpose of this invention, the terminology “optical fiber” is meant to encompass the optical fiber cable, as well as components thereof.

Emulsions and especially microemulsions are finding their most extensive, widespread use in a great variety of areas such as household cleaning, food, hygiene, pharmaceuticals, metal working, and many others. In some areas, for example cosmetics, they have almost become indispensable.

Methods of preparation of emulsions/microemulsions is richly taught in the chemical literature in general, and patent literature in particular. The following general references could be helpful: 1. Kirk-Othmer, Encyclopedia of Chemical Technology, 3rd. edition, vol.8, pp.900-930, 2. Microemulsions, L. M. Prince, Academic Press Inc., New York, 19977, 3. Microemulsions and Emulsions in Foods, ACS symposium Serie 448, 1991.

The invention encompasses both types of o/w and w/o emulsions and microemulsion. It will be up to one skilled in the art to decide which type is preferred for a given need in the processing sequence of optical fibers.

The salient, easily observable difference between emulsions and microemulsions is their appearance. Indeed, while emulsions are generally turbid, microemulsions are characteristically transparent, due to their finer, smaller particle or droplet size, generally in the range of a few Angstroms. For many embodiments of this invention, transparency of the liquid to be contacted with the optical fiber is essential, as many applications mentioned in the prior art call for visual observation of the fiber during exposure to a given liquid, for example solvent.

In general, microemulsions are preferred in order to satisfy the preferred embodiments of this invention. Indeed, microemulsions are generally clear, transparent, as mentioned earlier, and additionally have excellent thermodynamic, time/temperature stability. Not so for emulsions. Again, for the purpose of this invention, emulsion/microemulsion are defined in their basic, broad sense, meaning a mixture of two or more immiscible liquids. This definition of microemulsions does not exclude incorporation of solids, as shown in many instances of the prior art. Also, for the benefit of brevity, this invention will mainly be described in terms of microemulsions, though it expressly implies emulsions as well.

As can be seen in the prior art references cited above, optical fibers comprise an unusually broad range of diverse materials such as silica glass, organic and inorganic substances (the former being mainly organic polymers), metals, dyes, and others. Thus, in the construction of the final product or composit, a host of disciplines are called upon, with many other disciplines yet to be uncovered. Using microemulsions affords processing flexibility, as will be outlined further, and puts at the disposal of those skilled in the art a processing tool with broader processing window than hitherto practiced.

The exposure of the optical fibers to emulsion/microemulsion can be executed via immersion, spray, application in the form of gel, etc.

While persons skilled in the art will find a host of needs that can be more advantageously filled with microemulsions as compared to the prior art, following are a few typical embodiments envisioned by this patent:

1. Replace solvents with microemulsions especially, though not limitingly, where stripping is involved. One of the advantages of using microemulsions, is their ability to be used hot for improved solvency when needed. Also, the use of microemulsions in lieu of solvents can result in considerable economy.

2. Replace solvents with microemulsions where a coating needs to be softened in order to facilitate mechanical stripping. Again, elevated microemulsion temperature can be an asset.

3. Incorporate adhesion promoters into microemulsions, wherefrom they can be transferred to the surface to which a layer or coating is to be bonded to, whether primary, secondary, intermediate, or other, via contacting the surface to be -bonded- to, with the microemulsion containing the adhesion promoter. This approach will be often preferred and advantageous over incorporation of the adhesion promoter into the coating or layer to be applied, incorporation into solvents, gases, or other vehicles mentioned in the prior art. Indeed, with the microemulsion serving as vehicle, greater process flexibility can be achieved, because of better optimization of exposure time, temperature, adhesion promoter concentration in the microemulsion, controlled deposition of adhesion promoter, as desired/needed, leading to superior adhesion.

4. Fluorides are often encountered in the prior art, as a preferred compound in the pretreatment, surface preparation, of silica-based optical fibers for further processing. Incorporation of fluorides into microemulsions, with their inherent high interfacial activity, will lead to superior glass fiber topography.

5. The microemulsion can be designed to contain one or more of organic monomers, polymers, pigments and dyestuff, for delivery to a desired area of the optical fiber, for example during repairs.

### EXAMPLE

A silica-based optical fiber with a clear polymer coating was immersed in a microemulsion comprising a dye and prepared in accordance with Example 1 and Example 2 disclosed in U.S. Pat. No. 3,533,727. Following drying, the surface of the optical fiber was colored.

1. An improved method for processing optical fibers, comprising contacting the optical fiber with a stable microemulsion of the water-in-oil or oil-in-water type.

2. The method according to claim 1, wherein the microemulsion comprises at least one fluoride compound.

3. The method according to claim 1, wherein the microemulsion comprises at least one adhesion promoter.

4. The method according to claim 1, wherein the microemulsion comprises a polymeric monomer.

5. The method according to anyone of claims 1 to 4, wherein the microemulsion comprises a dyestuff.

6. The method according to claim 1, wherein the microemulsion is heated to a temperature above 30° C.
